(19) United States
(12) Patent Application Publication
(10) Pub. No.: US 2025/0053850 A1
(43) Pub. Date: Feb. 13, 2025

(54) SYSTEM AND METHODS FOR GENERATING INFERENCE INFORMATION ON A REVISABLE MODEL ON A STORAGE DEVICE

(71) Applicant: SK Hynix NAND Product Solutions Corp. (dba Solidigm), Rancho Cordova, CA (US)

(72) Inventors: Dan McLeran, Loveland, CO (US); Christopher Wilkerson, Mountain View, CA (US); Jim Baca, Longmont, CO (US)

(21) Appl. No.: 18/231,093

(22) Filed: Aug. 7, 2023

(51) Int. Cl. G06N 20/00

(52) U.S. Cl. CPC G06N 20/00

(57) ABSTRACT

A system and related method, including memory and processing circuitry, which is to receive multiple weights from a host device to implement an instantiation of a model on the storage device. The instantiation of the model includes multiple weights, and each weight is determined using another instantiation of the model that was trained on the host device. The processing circuitry is then to generate inference information using the instantiation of the model implemented on the storage device. The processing circuitry is further to receive multiple updated weights from the host device and update the instantiation of the model based on the multiple updated weights to implement an updated instantiation of the model on the storage device. The processing circuitry is then to generate updated inference information on the storage device using the updated instantiation of the model based on at least one signal to be processed by the processing circuitry.

### TECHNICAL FIELD

The present disclosure is directed to systems and methods for generating inference information using a model on a storage device based on at least one signal received by a host system.

### SUMMARY

In accordance with the present disclosure, systems and methods are provided for generating inference information on a storage device (e.g., a solid-state drive (SSD) device) using a revisable instantiation of a model based on at least one signal to be processed. The system and methods disclosed herein enable an instantiation of the model on a host (e.g. a first instantiation of the model) to be trained by the host without being in communication with the storage device and then update an instantiation of the model implemented on storage device (e.g., a second instantiation of the model). This allows for the first instantiation of the model to be trained by a centralized host while at least one storage device is using an implemented instantiation of the model (e.g., the second instantiation of the model), which can be updated at any time through receiving updated data. When the storage device receives signals to be processed, the storage device is to generate inference information using the instantiation of the model on the storage device based on at least one signal received. The system and methods disclosed herein use the revisable instantiation of the model on the storage device in order to enable a centralized host to maintain a trained instantiation of the model and then distribute updated weights to at least one storage device to implement updated instantiations on the storage devices. This system and methods disclosed herein offloads the task of training the instantiations of the model from each storage device, which allows each storage device to focus on the execution of operations rather than the training of the firmware or system, which would require a minimum amount of bandwidth and power from each storage device. This improves the overall access efficiency and power consumption of the processing circuitry of a storage device (e.g., a solid-state drive device).

In some embodiments, the system (e.g., a storage device) is provided with a memory and processing circuitry that are communicatively coupled to each other. In some embodiments the system can be distributed between a storage device and another device separate from the storage device (e.g., a host, such as a storage controller device), such as where the host provides control circuitry to implement at least some of the functionality described herein. In some embodiments, the processing circuitry receives updated weights from the host device. In some embodiments, the processing circuitry updates the instantiation of the model on the storage device based on the updated weights to implement an updated instantiation of the model on the storage device. The processing circuitry then generates inference information on the storage device using the updated instantiation of the model based on at least one signal to be processed.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows an illustrative diagram of a system including a host device and a storage device with a processing circuitry and memory, in accordance with some embodiments of the present disclosure;

FIG. 2 shows an illustrative diagram of a system including a host device in communication with multiple storage devices, in accordance with some embodiments of the present disclosure;

FIG. 3 shows an illustrative diagram of a host device training an instantiation of a model, in accordance with some embodiments of the present disclosure;

FIG. 4 shows a flowchart of illustrative steps for generating inference information on a storage device using an instantiation of a model based on at least one signal and updating the instantiation of the model on the storage device, in accordance with some embodiments of the present disclosure; and

FIG. 5 shows a flowchart of illustrative steps of a subprocess for generating inference information on the storage device using an instantiation of a model implemented on the storage device as shown in FIG. 4, in accordance with some embodiments of the present disclosure.

### DETAILED DESCRIPTION

In accordance with the present disclosure, systems and method are provided for generating inference information on a storage device (e.g., a solid-state drive (SSD) device) using a revisable instantiation of a model (e.g., a neural network, machine-learning neural network, or any other suitable neural network with a training/learning framework) based on at least one signal to be processed. An SSD device may implement a model to aid in instruction execution in which the model is trained on the SSD device, and in which operations being processed by the SSD are used as training data. However, if the processing circuitry of the SSD is tasked with training the model, the processing circuitry has less available bandwidth for processing instructions and for performing operations (e.g., reads and writes). In addition, in systems with more than one storage device, each storage device trains a respective instantiation of the model. In such a system, each SSD training their respective instantiation of the model compounds the limited bandwidth of the system. This leads to inefficiencies of the processing circuitry for each storage device.

If the processing circuitry of the SSD device could offload the training of the instantiation of the model to another device (e.g., a host), the available bandwidth improves for each storage device. In order to improve the efficiency of the SSD device, the processing circuitry may implement an instantiation of the model based on a trained instantiation of the model on a host device in order to process received signals. Therefore, the host is tasked with training an instantiation of the model and then sending updated data (e.g., updated weights for the model) in order to update the instantiation of the model on the storage device.

The processing circuitry generates inference information on the storage device by using an instantiation of a model implemented on the storage device. Each instantiation of the model includes multiple weights, each of the multiple weights determined using another instantiation of the model that was trained on a host coupled to the storage device. At some time after the instantiation of the model is implemented on the storage device the processing circuitry may receive multiple updated weights from the host. Once the processing circuitry receives multiple updated weights, the processing circuitry implements an updated instantiation of the model on the storage device based on the multiple updated weights. When the processing circuitry receives a signal to be processed, the processing circuitry generates updated inference information on the storage device based on at least the received signal to be processed using the updated instantiation of the model. In some embodiments, the processing circuitry may continuously update the instantiation of the model on the storage device by receiving further updated weights from the host.

In some embodiments, the memory of the system disclosed herein may contain any one of the following memory densities: single-level cells (SLCs), multi-level cells (MLCs), triple-level cells (TLCs), quad-level cells (QLCs) penta-level cells (PLCs), and any suitable memory density that is greater than five bits per memory cell.

For purposes of brevity and clarity, the features of the disclosure described herein are in the context of a storage device having processing circuitry and memory. However, the principles of the present disclosure may be applied to any other suitable context in which generating inference information on a storage device using a revisable instantiation of a model based on at least one signal to be processed is used. A storage device may include processing circuitry and memory, and the processing circuitry and memory are communicatively coupled by a network bus or interface. In some embodiments, the processing circuitry receives signals updated data (e.g., updated weights), which may be driven on a network bus or interface from a source outside of the storage device (e.g., the host) or may be transmitted from within the storage device (e.g., from memory).

In some embodiments, a processor of the processing circuitry may be a highly parallelized processor capable of handling high bandwidths of incoming data quickly. For example, the processing circuitry may initiate generating an inference information for a signal to be processed before the completion of generating inference information for a previously received signal to be processed.

In some embodiments the system and methods of the present disclosure may refer to a storage device system (e.g., an SSD storage system), which includes a storage device such as a solid-state drive device, which is communicatively coupled to the processing circuitry by a network bus or interface.

An SSD is a data storage device that uses integrated circuit assemblies as memory to store data persistently. SSDs have no moving mechanical components, and this feature distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency.

Many types of SSDs use NAND-based flash memory which retain data without power and include a type of non-volatile storage technology. Quality of Service (QOS) of an SSD may be related to the predictability of low latency and consistency of high input/output operations per second (IOPS) while servicing read/write input/output (I/O) workloads. This means that the latency or the I/O command completion time needs to be within a specified range without having unexpected outliers. Throughput or I/O rate may also need to be tightly regulated without causing sudden drops in performance level.

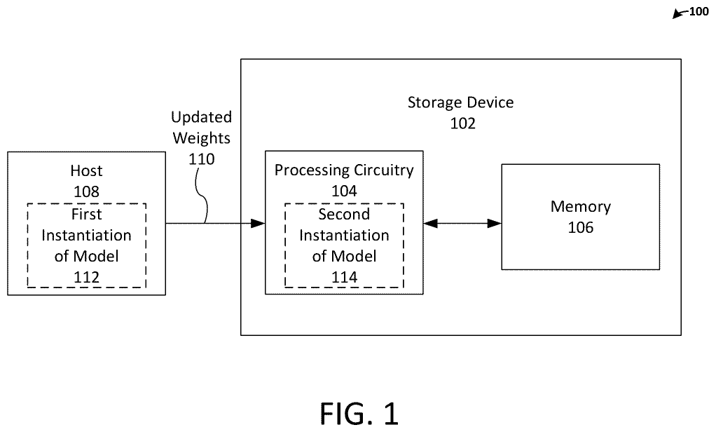

The subject matter of this disclosure may be better understood by reference to FIGS. 1-5.

FIG. 1 shows an illustrative diagram of a system 100 including a host device (e.g., host 108) and a storage device 102 with a processing circuitry 104 and memory 106, in accordance with some embodiments of the present disclosure. In some embodiments, storage device 102 may be a solid-state storage device (e.g., a solid-state drive (SSD) device). In some embodiments, processing circuitry 104 may include a processor or any suitable processing unit. In some embodiments, memory 106 may be non-volatile memory. It will be understood that the embodiments of the present disclosure are not limited to SSDs. For example, in some embodiments, the storage device 102 may include a hard disk drive (HDD) device in addition to or in place of an SSD. In some embodiments, system 100 includes a host 108, which communicates with the storage device 102.

The host 108 includes a first instantiation of the model 112, which may be implemented on control circuitry of the host 108. In some embodiments, the control circuitry trains the first instantiation of the model 112 by using simulated signals. The first instantiation of the model 112 is used to determine weights (e.g., updated weights 110) based on the training by the host 108. Each weight of a model contributes to the decision-making of a determined outcome or result based on an input (e.g., a received signal to be processed). Once the processing circuitry 104 receives the weights from the host 108, the processing circuitry 104 implements the second instantiation of the model 114 on the storage device 102. The processing circuitry 104 then generates inference information on the storage device using the second instantiation of the model 114 based on at least one signal to be processed. The second instantiation of the model 114 may be updated when the processing circuitry 104 receives updated weights 110 from the host 108. In some embodiments, the second instantiation of the model 114 can be updated at any time through receiving updated data (e.g., updated weights 110) though any suitable firmware update request.

In some embodiments, the processing circuitry 104 is configured to generate inference information on the storage device using the second instantiation of the model 114 implemented on the storage device 102. In some embodiments, the second instantiation of the model 114 is implemented based on weights received from the host 108, which determines the weights by training the first instantiation of the model 112. The processing circuitry is further to receive multiple updated weights from the host 108 and then update the second instantiation of the model 114 based on the multiple updated weights in order to implement an updated instantiation on the storage device 102. Once the second instantiation of the model 114 is updated to the updated instantiation of the model, the processing circuitry 104 then determines updated inference information on the storage device 102 using the updated instantiation of the model based on at least one signal to be processed. In some embodiments, the garbage collection requests includes a destination memory address which corresponds to a destination data that may be stale or invalid. In some embodiments, garbage collection requests and weights (e.g., updated weights 110) are transmitted on a network bus or interface to the processing circuitry 104. In some embodiments, garbage collection requests and weights (e.g., updated weights 110) are transmitted from an external source (e.g., host 108). In some embodiments, the processing circuitry 104 receives signals (e.g., garbage collection requests and updated weights 110) from both internal and external sources of the storage device 102. There may also be a temporary memory (e.g., a cache or queue) disposed within the processing circuitry 104, the temporary memory configured to store any outstanding request that is to be processed by the processing circuitry 104.

Additionally, storage device 102 includes memory 106. In some embodiments, memory 106 includes any one or more of a non-volatile memory, such as Phase Change Memory (PCM), a PCM and switch (PCMS), a Ferroelectric Random Access Memory (FeRAM), or a Ferroelectric Transistor Random Access Memory (FeTRAM), a Memristor, a Spin-Transfer Torque Random Access Memory (STT-RAM), and a Magnetoresistive Random Access Memory (MRAM), any other suitable memory, or any combination thereof. In some embodiments, memory 106 may include volatile memory in the form of a cache. In some embodiments, memory 106 may include any one of single-level cell (SLC) memory, multi-level cell (MLC) memory, triple-level cell (TLC) memory, quad-level cell (QLC) memory, penta-level cell (PLC) memory, or any other suitable memory that has a memory density greater than 5 bits per memory cell. In some embodiments, processing circuitry 104 is communicatively coupled to memory 106, in order to store and access data used for executing signals/requests. In some embodiments, a data bus between the memory 106 and processing circuitry 104 provides a network bus for accessing or writing of data to memory 106. In some embodiments, the processor or processing unit of processing circuitry 104 may include a hardware processor, a software processor (e.g., a processor emulated using a virtual machine), or any combination thereof. The processor, also referred to herein as processing circuitry 104, may include any suitable software, hardware, or both for controlling the memory 106 and the processing circuitry 104. In some embodiments, the storage device 102 may further include a multi-core processor. Memory 106 may also include hardware elements for non-transitory storage of instructions, commands, or requests.

The processing circuitry 104 is configured to generate inference information on a storage device using a revisable instantiation of a model based on at least one signal to be processed, where the instantiation of a model is implemented on the storage device using weights received from a host device with another instantiation of the model that has been trained on the host device. In addition, the processing circuitry 104 may receive updated weights 110 from the host 108. The updated weights 110 are determined by using a first instantiation of a model 112, which is trained on the host 108. The updated weights 110 are used to implement a second instantiation of the model 114 on the storage device 102. Each weight of a model contributes to the decision-making of a determined outcome or result based on an input (e.g., a received signal to be processed). Once the processing circuitry 104 receives the updated weights 110 from the host 108, the processing circuitry 104 updates the second instantiation of the model 114 on the storage device 102. The processing circuitry 104 then generates updated inference information on the storage device using the updated second instantiation of the model based on at least one signal to be processed. These processes enable an instantiation of the model on the host 108 (e.g. the first instantiation of the model 112) to be trained by the host 108 without being in communication with the storage device 102 and then update the instantiation of the model implemented on storage device 102 (e.g., the second instantiation of the model 114). This allows for an instantiation of the model to be trained by a centralized host 108 while at least one storage device (e.g., storage device 102) is using an implemented instantiation of the model (e.g., the second instantiation of the model 114), which can be updated at any time through receiving updated data (e.g., updated weights 110) though any suitable firmware update request.

Storage devices (for example, SSD devices) may include one or more packages of memory dies (e.g., including memory 106), where each die includes storage cells. In some embodiments, the storage cells are organized into pages, and pages are organized into blocks. Each storage cell can store one or more bits of information.

It will be understood that, while system 100 depicts an embodiment in which a storage device 102 is configured to have capabilities for generating inference information on a storage device using a revisable instantiation of a model based on at least one signal to be processed in accordance with the present disclosure, any other suitable device may be implemented in a similar manner.

For purposes of clarity and brevity, and not by way of limitation, the present disclosure is provided in the context of generating inference information on a storage device using a revisable instantiation of a model based on at least one signal to be processed, which provides the features and functionalities disclosed herein. The process of generating inference information on a storage device using a revisable instantiation of a model based on at least one signal to be processed may be configured by any suitable software, hardware, or both for implementing such features and functionalities. Generating inference information on a storage device using a revisable instantiation of a model based on at least one signal to be processed may be at least partially implemented in, for example, storage device 102 (e.g., as part of processing circuitry 104, or any other suitable device). For example, for a solid-state storage device (e.g., storage device 102), the generation of inference information on a storage device using a revisable instantiation of a model based on at least one signal to be processed may be implemented in processing circuitry 104

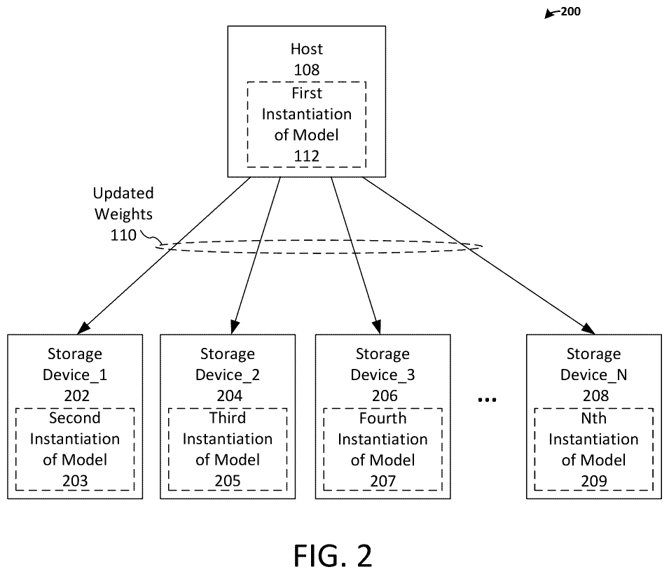

FIG. 2 shows an illustrative diagram of a system 200 including a host device 108 in communication with multiple storage devices (e.g., storage device_1 202, storage device_2 204, storage device_3 206, and storage device_N 208), in accordance with some embodiments of the present disclosure.

The host 108 includes a first instantiation of the model 112, which may be implemented on and trained by control circuitry of the host 108. The host 108 is communicatively coupled to each of the storage device (e.g., 202, 204, 206, and 208) by a network interface or data bus. Each respective storage device (e.g., 202, 204, 206, and 208) has a respective instantiation of the model (e.g., second instantiation of the model 203, third instantiation of the model 205, fourth instantiation of the model 207, and the Nth instantiation of the model 209) implemented on the respective storage device. The host 108 is configured to train the first instantiation of the model 112 to determine updated weights 110, which are sent to each of the storage devices (e.g., storage device_1 202, storage device_2 204, storage device_3, and storage device_N 208) through the network interface or data bus. Once a respective storage device receives the updated weights 110 from the host 108, the respective storage device 102 updates the respective instantiation of the model using the updated weights 110. This system 200 enables a distributed systems with multiple storage devices with instantiations of a model where the instantiations of the model can be updated simultaneously.

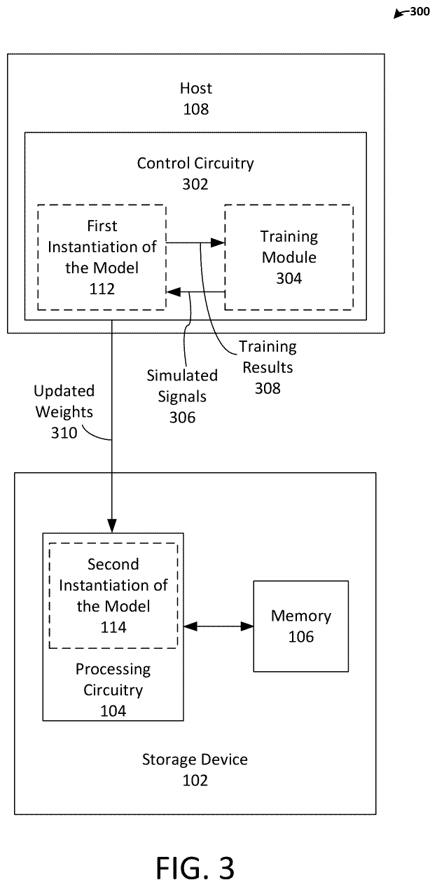

FIG. 3 shows an illustrative diagram of a host 108 training an instantiation of a model (e.g., a first instantiation of the model 112), in accordance with some embodiments of the present disclosure. The host 108 includes control circuitry 302, the first instantiation of the model 112 implemented on the control circuitry 302 and a training module 304. The training module 304 is configured to send simulated signals 306 to the first instantiation of the model 112 to train the first instantiation of the model 112. The first instantiation of the model 112 generates training results 308 based on the simulated signals 306 and sends the training results 308 to the training module 304. In some embodiments, the training module 304 is further to compare expected training results that correspond to the simulated signals 306 and the training results 308 generated by the first instantiation of the model 112. The weights of the first instantiation of the model 112 may be adjusted based on the comparison of the training results 308 and the expected training results that correspond to the simulated signals 306. In some embodiments, the comparison of training results 308 to expected training results may also be used to determine the efficacy of the first instantiation of the model 112, and whether the first instantiation of the model needs to be trained further.

At any time, the control circuitry 302 of the host 108 may send updated weights 310 to the storage device 102. In some embodiments, the updated weights 310 are received by the processing circuitry 104 and are used to implement the second instantiation of the model 114. In some embodiments, the updated weights 310 are send to the storage device 102 through a data bus or network interface that communicatively couples the host 108 to the storage device 102. In some embodiments, the first instantiation of the model 112 is trained by the control circuitry 302 without being in communication with the storage device 102 and then update the instantiation of the model implemented on storage device 102 (e.g., the second instantiation of the model 114).

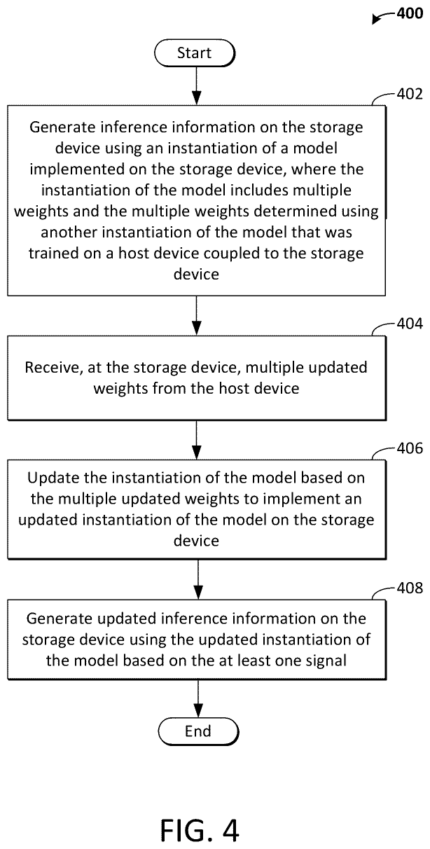

FIG. 4 shows a flowchart 400 of illustrative steps for generating inference information on a storage device using an instantiation of a model based on at least one signal and updating the instantiation of the model on the storage device, in accordance with some embodiments of the present disclosure. In some embodiments, the referenced storage device, processing circuitry, memory, host, updated weights, first instantiation of the model, the second instantiation of the model, control circuitry, training module, and simulated signals may be implemented as storage device 102, processing circuitry 104, memory 106, host 108, updated weights 110, first instantiation of the model 112, second instantiation of the model 114, control circuitry 302, training module 304, and simulated signals 306, respectively. In some embodiments, the process 400 can be modified by, for example, having steps rearranged, changed, added, and/or removed.

At step 402, the processing circuitry generates inference information on the storage device using an instantiation of a model implemented on the storage device, wherein the instantiation of the model includes multiple weights, each of the multiple weights determined using another instantiation of the model that was trained on a host device coupled to the storage device. In some embodiments, the processing circuitry implements an instantiation of the model (e.g., the second instantiation of the model) on the storage device by using multiple weights received from the host. In some embodiments, the host includes control circuitry to train another instantiation of the model (e.g., the first instantiation of the model) using simulated signals that are similar to the expected signals that the processing circuitry will receive and process. In addition, the control circuitry of the host may include a training module to create and send the simulated signals to the other instantiation of the model (e.g., the first instantiation of the model) and then compare expected results of the simulated signals to testing results received from the other instantiation of the model (e.g., the first instantiation of the model). In some embodiments, the host trains the other instantiation of the model based on simulated signals while the host is not communicatively coupled to the storage device. The weights are determined by the host and sent to the processing circuitry of the storage device in order to implement the instantiation of the model (e.g., the second instantiation of the model). In some embodiments, the processing circuitry generates inference information using the implemented instantiation of the model based on at least one signal received by the processing circuitry. In some embodiments, the generated inference information includes a predicted operation for the processing circuitry to execute based on at least one received signals. In some embodiments, the predicted operations may be any one of a workload detection operation, a thermal operation, a storage device optimization operation, or a storage device arbitration operation. Once inference information is generated on the storage device, the processing circuitry may receive multiple updated weights from the host device, at step 404.

At step 404, the processing circuitry receives at the storage device multiple updated weights from the host device. In some embodiments, the processing circuitry receives the multiple updated weights from a firmware update request sent from the host. In some embodiments, the processing circuitry receives the updated weights from a network interface or data bus which communicatively couples the storage device to the host. When the processing circuitry of the storage device receives multiple updated weights from the host device, the processing circuitry then updates the instantiation of the model based on the multiple updated weights in order to implement an updated instantiation of the model on the storage device, at step 406.

At step 406, the processing circuitry updates the instantiation of the model based on the multiple updated weights to implement an updated instantiation of the model on the storage device. In some embodiments, the number of updated weights may be the same as the number of weights that implemented an original instantiation of the model on the storage device. Once the updated instantiation of the model is implemented on the storage device, the processing circuitry generates updated interference information on the storage device using the updated instantiation of the model based on at least one signal to be processed, at step 408.

At step 408, processing circuitry generates updated inference information on the storage device using the updated instantiation of the model based on at least one signal to be processed. In some embodiments, the generated updated inference information is a predicted operation for the processing circuitry to execute based on at least one signal. In some embodiments, given the same signal received by the processing circuitry, the updated inference information generated using the updated instantiation of the model may be different from the inference information generated using the previous version of the instantiation of the model. In some embodiments, the updated instantiation of the model may be updated when the processing circuitry receives any other updated weights from the host.

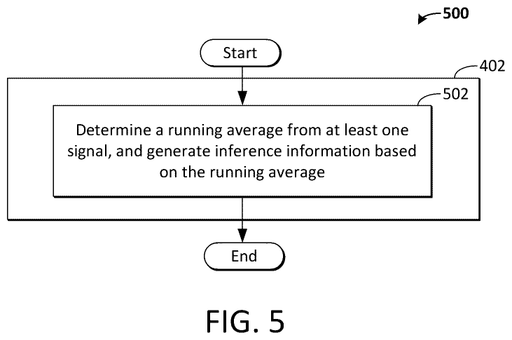

FIG. 5 shows a flowchart of illustrative steps of a subprocess for generating inference information on the storage device using an instantiation of a model implemented on the storage device (e.g., as shown in FIG. 4, at 402), in accordance with some embodiments of the present disclosure. In some embodiments, the referenced storage device, processing circuitry, memory, host, updated weights, first instantiation of the model and the second instantiation of the model may be implemented as storage device 102, processing circuitry 104, memory 106, host 108, updated weights 110, first instantiation of the model 112 and second instantiation of the model 114, respectively. In some embodiments, the subprocess 500 can be modified by, for example, having steps rearranged, changed, added, and/or removed.

At step 502, the processing circuitry determines a running average from the at least one signal that is to be processed and generates inference information based on the determined running average. In some embodiments, the running average may be determined based on a predetermined number of signals received by the processing circuitry. For example, an instantiation of a model implemented on the storage device may be used to generate inference information for workload detection. In such an example, the processing circuitry of the storage device may receive signals such as instructions or operations to be processed by the processing circuitry and then predict expected instructions or operations based on a running average on previously received signals. In some embodiments, the running average is continuously adjusted based on the most recently received signal at the storage device.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A method for processing at least one signal on a storage device, the method comprising:
generating inference information on the storage device using an instantiation of a model implemented on the storage device, the instantiation of the model comprising a plurality of weights, wherein the plurality of weights were determined using another instantiation of the model that was trained on a host device coupled to the storage device;
receiving at the storage device a plurality of updated weights from the host device;
updating the instantiation of the model based on the plurality of updated weights to implement an updated instantiation of the model; and
generating updated inference information on the storage device using the updated instantiation of the model based on the at least one signal.

2. The method of claim 1, wherein the other instantiation of the model is trained on the host device based on simulated data while the host device is not communicatively coupled to the storage device.

3. The method of claim 2, wherein the simulated data used to train the other instantiation of the model is determined by the host device based on a subset of expected signals to be processed by the instantiation of the model on the storage device.

4. The method of claim 1, wherein inference information comprises a predicted operation from a plurality of operations.

5. The method of claim 4, wherein the plurality of operations comprises of any one or more of the following: (a) a workload detection operation, (b) a thermal arbitration operation, (c) a device power optimization operation, or (d) a device bandwidth arbitration operation.

6. The method of claim 1, wherein generating inference information on the storage device using an instantiation of the model comprises:
determining a running average from the at least one signal, and wherein generating inference information comprises generating inference information based on the running average.

7. A storage device, comprising:
memory; and
processing circuitry to:
receive a plurality of weights from a host device to implement an instantiation of a model on the storage device, wherein the instantiation of the model comprises a plurality of weights, each weight of the plurality of weights determined using another instantiation of the model that was trained on the host device,
generate inference information using the instantiation of the model implemented on the storage device,
receive a plurality of updated weights from the host device,
update the instantiation of the model based on the plurality of updated weights to implement an updated instantiation of the model, and
generate updated inference information on the storage device using the updated instantiation of the model based on an at least one signal to be processed.

8. The storage device of claim 7, wherein the other instantiation of the model is trained on the host device based on simulated data while the host device is not communicatively coupled to the storage device.

9. The storage device of claim 8, wherein the simulated data used to train the other instantiation of the model is determined by the host device based on a subset of expected signals to be processed by the instantiation of the model on the storage device.

10. The storage device of claim 7, wherein inference information comprises a predicted operation from a plurality of operations.

11. The storage device of claim 10, wherein the plurality of operations comprises of any one or more of the following: (a) a workload detection operation, (b) a thermal arbitration operation, (c) a device power optimization operation, or (d) a device bandwidth arbitration operation.

12. The storage device of claim 7, wherein to generate inference information on the storage device using an instantiation of the model the processing circuitry is to:
determine a running average from the at least one signal, and wherein generate inference information comprises generating inference information based on the running average.

13. A system, comprising:
a host, comprising:
control circuitry, coupled to a communications bus, to:
train a first instantiation of a model to provide an inferencing output, wherein the first instantiation of the trained model comprises a plurality of weights,
communicate the plurality of weights to a storage device using the communications bus, and
communicate a plurality of updated weights to the storage device using the communications bus, and
the storage device, coupled to the communications bus, the storage device comprising:
memory; and
processing circuitry to:
receive the plurality of weights,
implement a second instantiation of the model on the storage device based on the plurality of weights,
generate inference information using the second instantiation of the model based on an at least one signal to be processed,
receive a plurality of updated weights from the host,
update the second instantiation of the model based on the plurality of updated weights to implement an updated second instantiation of the model, and
generate updated inference information using the updated second instantiation of the model.

14. The system of claim 13, wherein the first instantiation of the trained model is trained on the host based on simulated data while the host is not communicatively coupled to the storage device.

15. The system of claim 14, wherein the simulated data used to train the first instantiation of the trained model is determined by the control circuitry based on a subset of expected signals to be processed by the second instantiation of the model.

16. The system of claim 14, wherein the control circuitry is further to:
communicate the simulated data to the first instantiation of the model,
receive training results from the first instantiation of the model,
in response to a comparison of the training results to expected training results that correspond to the simulated data, determine modified simulated data, and
communicate the modified simulated data.

17. The system of claim 13, wherein inference information comprises a predicted operation from a plurality of operations.

18. The system of claim 17, wherein the plurality of operations comprises of any one or more of the following: (a) a workload detection operation, (b) a thermal arbitration operation, (c) a power optimization operation, or (d) a bandwidth arbitration operation.

19. The system of claim 13, wherein to generate inference information using an instantiation of the trained model the processing circuitry is to:
determine a running average from the at least one signal, and wherein generate inference information comprises generating inference information based on the running average.

20. The system of claim 13, further comprising a plurality of storage devices, wherein the storage device is one of the plurality of storage devices and each storage device is coupled to the host through the communications bus.
